(19) United States
(12) Patent Application Publication
(10) Pub. No.: US 2015/0096770 A1
(43) Pub. Date: Apr. 9, 2015

(54) Device for Distribution of Fire Suppressant

(71) Applicant: GelTech Solutions, Inc., Jupiter, FL (US)

(72) Inventor: Peter Cordani, Palm Beach Gardens, FL (US)

(21) Appl. No.: 14/309,229

(22) Filed: Jun. 19, 2014

Related U.S. Application Data
(63) Continuation-in-part of application No. 14/045,386, filed on Oct. 3, 2013.

(51) Int. Cl. A62C 35/02; A62C 3/00

(52) U.S. Cl. CPC A62C 35/023; A62C 3/00
USPC 169/54

(57) ABSTRACT

A device for protecting a lineman or firefighter from an electrical fire that occurs while working within a manhole. The device dispenses a non-conductive amount of fire suppressant material having fire suppression and extinguishing properties without creating an electrically conductive environment. The admixture preferably can cling to walls, ladders, clothing and skin.

### PRIORITY CLAIM

In accordance with 37 CFR §1.76, a claim of priority is included in an Application Data Sheet filed concurrently herewith. Accordingly, the present invention claims priority as a continuation-in-part of U.S. patent application Ser. No. 14/045,386, entitled “DEVICE OF TREATING MANHOLE ELECTRICAL FIRES”, filed Oct. 3, 2013. The contents of which the above referenced application is incorporated herein by reference.

### FIELD OF THE INVENTION

This invention relates to the field of fire prevention, and more particularly to a device for placement around a manhole for dispersion of a fire suppressant to shield a worker while working within a manhole should a fire occur.

### BACKGROUND OF THE INVENTION

In many cities the utilities are located beneath the surface of the earth, usually beneath the surface of the streets. These utilities are usually placed in tunnels or conduits. In the older cities, such as New York City, these utilities have been located in these tunnels or conduits for many years/decades. Over time, the conduits which carry these utilities wear out and break. A serious problem is the failure of electrical transmission lines in conduits and tunnels. These failures usually result in fires which must be quickly extinguished to prevent further damage.

While it is desirable to replace very old utilities in conduits and tunnels, it is not always practical. Due to financial restraints and other limitations, most of these electrical transmission lines have not been replaced. Unfortunately, failure of older electrical transmission lines can result in an electrical fire. These fires are commonly discovered when smoke is seen arising from manhole covers in the streets and sidewalks. It has been estimated by Consolidated Edison that there are approximately 40 electrical fires per day under the streets of New York City.

The cost of repairing and replacing the electrical transmission lines damaged by these fires is approximately $100,000.00 per linear foot of transmission line. Therefore, it is imperative that these fires be extinguished as quickly as possible. Inspection of lines can help pinpoint potential trouble areas. Unfortunately, inspection of the lines can trigger a fire. For instance, the opening of a manhole cover can provide the oxygen needed to support a fire. Similarly, a lineman performing an inspection may disturb a conduit resulting in arcing of electric lines, possibly triggering a fire.

Normally a lineman inspecting a potential problem area occurs while electrical power is still flowing through the lines. The inspection takes place within the manhole wherein a lineman inserts himself into the manhole. Typically a ladder is placed through the manhole and the lineman climbs down the ladder to permit inspection from within. Unfortunately the lineman can trigger a fire, or simply be in the wrong place at the wrong time. There have been many instances wherein a fire begins while the lineman is on the ladder. For instance, a fire may be smoldering as evidence by smoking coming out of the manhole. A lineman or fireman may then enter the manhole, and without notice, the smoldering may burst into an all encompassing fire. In many such instances, the individual who climbed into the manhole is now at risk of injury or death.

What is needed is a device that provides fire protection to the individual that climbs through the manhole for servicing of the electrical grid in the tunnels beneath the ground surface.

### DESCRIPTION OF THE PRIOR ART

U.S. Pat. No. 6,834,728 discloses a system for extinguishing a fire in a tunnel. The system includes a conduit for delivering a fire extinguishing liquid and a trough extending parallel to the conduit for receiving liquid from the conduit. A carriage is arranged to move on a track which includes an upper edge of the trough. The carriage carries a pump having a nozzle, a video camera, and an inlet; each of which can be controlled robotically from a remote control station. The inlet is deployed in the trough to draw liquid from the trough.

U.S. Pat. No. 7,096,965 discloses a method of proportioning a foam concentrate into a non-flammable liquid to form a foam concentrate/liquid mixture and create a flowing stream of the foam concentrate/liquid mixture. Nitrogen is introduced into the stream of the foam/liquid mixture to initiate the formation of a nitrogen expanded foam fire suppressant. The flowing stream carrying the nitrogen expanded foam is dispensed, which completes the full expansion of the nitrogen expanded foam fire suppressant, into the confined area involved in the fire, thereby smothering the fire and substantially closing off contact between combustible material involved in the fire and the atmosphere. The apparatus of this invention is adapted for expanding and dispensing foam and includes a housing defining an interior through which extends a discharge line. The ends of the housing are closed about the ends of the discharge line, and the ends of the discharge line extend beyond the ends of the housing to define a connector at one end for receiving a stream of foam concentrate/liquid and at the opposite end to define the foam dispensing end of the apparatus. A portion of the discharge line in the housing defines an eductor for the introduction of expanded gas into the stream of foam concentrate/liquid flowing through the discharge line.

U.S. Pat. No. 7,124,834 discloses a method for extinguishing a fire in a space such as a tunnel. The method includes spraying a fire extinguishing medium into the space by spray heads. In a first stage of the method, the flow and temperature of the hot gases produced by the fire are influenced by spraying an extinguishing medium into the space, especially by creating in the space at least one curtain of extinguishing medium. At least some spray heads in the space are pre-activated into a state of readiness. In a second stage of the method, at least one spraying head is activated to produce a spray of extinguishing medium.

U.S. patent application Ser. No. 11/680,803 is entitled “Process for Fire Prevention and Extinguishing”, the contents of which are incorporated herein by reference. In this application, a process for retarding or extinguishing conflagrations using a fire suppressant in water is disclosed. The reaction of the water with the polymer creates a gel-like substance with a viscosity that allows the mixture to be readily pumped through a standardized 2.5 gallon water based fire extinguisher, yet viscous enough to cover vertical and horizontal surfaces to act as a barrier to prevent fire from damaging such structures, minimizing the manpower needed to continuously soak these structures.

### SUMMARY OF THE INVENTION

A device for suppressing the spread of and extinguishing electrical fires in manhole areas. The device includes a distribution ring that is placed over a manhole and distributes a fire suppressant into the manhole covering the individual and the area direction around the ladder used by the individual to enter the manhole. Known fire suppressants have substantially superior fire suppression and extinguishing properties over plain water and are preferably non-conductive.

Accordingly, it is an objective of the present invention to provide a device for placement in a manhole for suppressing fires in confined areas.

It is a further objective of the present invention to provide a device that is manually triggered by the individual in the manhole, or a person outside the manhole, to release material capable of extinguishing and suppressing the spread of electrical fires in the manhole; the manual trigger is a solenoid operated valve operated by switches attached to the end of extension cords.

It is a further objective of the present invention to provide a device that is manually triggered by the individual in the manhole, or a person outside the manhole, to release material capable of extinguishing electrical fires and suppressing the spread of electrical fires in the manhole; the manual trigger is a solenoid operated valve operated by wireless RF controllers.

It is a further objective of the present invention to provide a device that is automatically triggered to release material capable of extinguishing electrical fires and suppressing the spread of electrical fires in the manhole. The automatic trigger is a heat sensitive nozzle that is ready to dispense material upon the presence of heat.

It is yet another objective of the present invention to provide a device that sprays a material coating over the individual calculated to provide the individual time to extract themselves from the manhole.

It is still yet another objective of the present invention to provide a device to work with a unique admixture of fire suppressant which has viscosity sufficient to enable it to retain positioning for a period of time. The viscosity also enables the admixture to adhere to horizontal, vertical, inclined, and curved surfaces.

It is a still further objective of the present invention to provide a device for protecting of personnel, extinguishing or suppressing of an electrical fire.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial view of a device for treating manhole electrical fires;

FIG. 2 is a pictorial view of the device using a wireless transmitter;

FIG. 3 is a pictorial view of the distributor nozzle;

FIG. 4 is a side view of the distributor nozzle; and

FIG. 5 is a cross sectional view of the distributor nozzle.

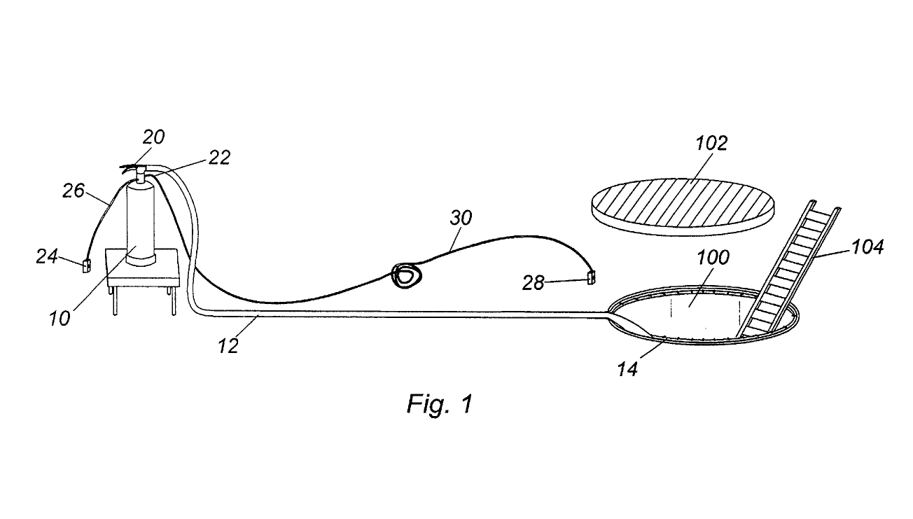

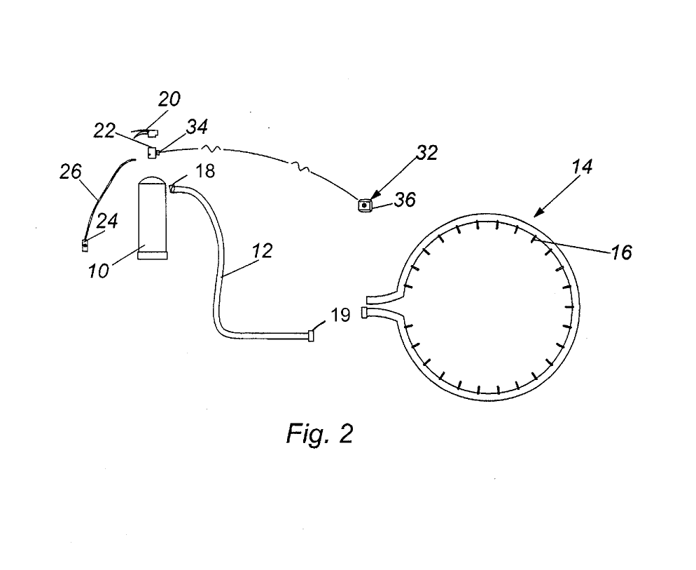

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to a unique technique or method of extinguishing electrical fires and suppressing the spread of electrical fires. This unique technique utilizes a fire suppressant in an amount sufficient to extinguish an electrical fire and suppress the spread of the electrical fire. Know fire suppressants marketed under the brand name of FIREICE, CEMDAL AQUA SHIELD, BARRICADE, THERMO-GEL, WILDFIRE AFG FIREWALL, BIOCENTRAL BLAZETAMMER, PHOS-CHEK INSUUL, and THERMO GEL. As used herein, a “fire suppressant” composition is meant to be inclusive of all components of the composition. In some embodiments, the fire suppressant composition comprises one or more fire suppressant compounds. In other embodiments, the fire suppressant composition comprises one or more common components of fire suppressant formulations, such as: fire suppressant salts, conventional fire suppressants, corrosion inhibitors, spoilage inhibitors, foaming agents, non foaming agents, flow conditioners, stability additives, thickening agents, conventional fire suppressants or the like. In some embodiments, the fire suppressant or compositions thereof is in dry form. In other embodiments, the fire suppressant or compositions thereof are hydrated. The fire suppressant or compositions thereof can be a liquid or semi-liquid form, such as, for example, gel having varying viscosities. The fire suppressant compositions can be any known fire suppressants, including biodegradable, super absorbent, aqueous based polymers. Examples of these polymers are cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids.

Referring to the Figures, the present invention relates to a device used to protect personnel that are within a manhole, which could be subject to an electrical fire within the manhole. Electrical fires present different and unique problems pertaining to how these fires should be extinguished and suppressed. Water is normally used to fight fires because it can quickly cool down the burning material, there is usually a large supply of it ready for use, and it is relatively inexpensive. However, water and electricity are harmful, if not deadly to individuals, when brought into contact with each other. Normally, when water hits an active electrical circuit or electrical component, it shorts out the circuit or component, which usually results in destruction of the circuit or component. Further, when individuals are in close proximity to the water contacting the electricity, there is a strong likelihood that the water will act as a conductor and conduct the electricity to the individuals, resulting in serious injury or death of the individuals. Since water spreads rapidly in all directions on surfaces, electricity which comes in contact with the water will be conducted to wherever the water flows. Because it is difficult to prevent water from flowing to certain areas, there is a strong likelihood that individuals will be injured or killed when they come in contact with this water.

In the preferred embodiment of the present invention, a fire suppressant having properties in an amount which enable the fire suppressant to be applied over the individual and remain within the confined area due to its relatively high viscosity. The properties of the admixture, in particular its viscosity, should enable the admixture to be applied to remain on vertical, horizontal, and curved surfaces of the ladder used by the individual to enter the manhole. Unlike pure water, the known fire suppressants do not provide an electrically conductive path permitting the individual time to get out of the manhole without being electrocuted. The present invention adds a predetermined amount of the fire suppressant to obtain an admixture which has properties that enable the admixture to suppress the spread of an electrical fire and extinguish any fire that has attached itself to the individual. The adherence of the admixture of fire suppressant to the clothing of the individual lowers the temperature of the clothing below a combustion temperature thereby giving the individual time to exit the manhole. In addition, adherence of the admixture of fire suppressant to the clothing should maintain moisture content at a level which suppresses the spread of the fire by preventing combustion of the clothing from hot embers and/or flames. Further, placing the admixture upon exposed skin deters burning of the skin.

Currently, firefighters apply water to the electrical conduits/components which are on fire and also to adjacent conduits/components because it is difficult to control where the water goes. This contact of water on electrical conduits/components that are not on fire results in substantial unnecessary damage to these conduits/components. The present invention, on the other hand, enables a controlled dispersion of fire suppressant to a specific area for the primary purpose of protecting the individual from the fire, and giving the individual time to escape the manhole. The mixture adheres to the individual and the ladder, without affecting adjacent conduits/components. Thus, a substantial safety factor is gained because electrical conduits/components are not sprayed, and even if they are sprayed, the admixture should not be conductive.

When there are electrical fires in underground tunnels or conduits, the firefighters contact the electrical utility to have the electrical power turned off so they can fight the fire. In rare instances, the electrical power is not turned off which may result in serious injury and/or death of the firefighters when they apply water to the electrical fire. The present invention produces an admixture having properties such that the admixture will not readily flow or run from the area into which the admixture has been applied. If the fire suppressant contains a large amount of water, if the admixture is applied to a live electrical wire or component, the admixture should be such that electricity will not travel back to the firefighter due to its physical properties.

Referring to the Figures, a container 10 holding the fire suppressant is positioned a distance from a manhole 100 shown with the manhole cover 102 removed and a ladder 104 placed within the manhole 100. Within the manhole are utilities in an underground tunnel or conduit, not shown. These utilities can be electrical cables, telephone lines, water supply lines, and so forth. The manhole 100 permits individuals to gain access to the underground tunnel.

The container 10 holds a mixture of fire suppressant in an amount to form an admixture. The container 10 can be premixed or mixed on location. The container 10 can hold from 5 to 30 gallons of the admixture, the higher amount providing the longer dispensing period and thus providing the individual within the manhole time to exit as necessary. The admixture is directed into the manhole 100 by use of a distribution ring 14 that is fluidly coupled to the container 10 by a fluid hose 12. The hose can be 10-50 foot long allowing the placement of the container a distance from the manhole 100. Quick release couplings 18 and 19 are used to connect the fluid hose 12 to the container 10 and distribution ring 14. The distribution ring 14 is constructed an arranged to be placed about the circumference of the manhole 100 opening so that an individual can enter and exit uninhibited. The distribution ring 14 has a plurality of spray nozzles 16 to direct the admixture into the manhole 100 should an individual working within the manhole 100 require fire protection. The spray nozzles 16 are constructed and arranged to distribute an amount of the admixture in sufficient quantity to cover the individual, the ladder, and the immediate area beneath the manhole. If the individual's clothing is on fire, the admixture will extinguish the fire and suppress the spread of the fire. The admixture will also protect the individual's skin from exposure to the fire. Further, the admixture will inhibit the fire from damaging the integrity of the ladder so as to provide the individual with sufficient time to exit the manhole.

The container 10 can be manually discharged like a conventional fire extinguisher wherein handle 20 can be manually operated by a co-worker monitoring the individual within the manhole 100. A solenoid 22 is also positioned at the container 10 allowing for a remote discharge of the container 10. In the preferred embodiment, a first remote activator 24 is tethered to the solenoid 22 by a cable 26. Should a need occur, the co-worker monitoring the individual within the manhole 100 may activate the system by depressing a trigger switch located on the remote activator 24 which opens the solenoid 22 allowing for the disbursement of the admixture within the container 10 to the manhole. The cable 26 can be of a length that allows the co-worker quick access for disbursement yet freedom to continue other duties. It is contemplated that the container 10 is mounted on a vehicle. By way of example, a coworker may place the first remote into the cabin area in adverse weather conditions wherein the coworker can monitor the manhole 100 from a remote location, should a fire erupt in the manhole 100 while an individual is within the manhole 100, the coworker could immediately trigger a discharge.

In addition, a second remote activator 28 is tethered to the solenoid 22 by a cable 30 that allows the worker or fireman who entered the manhole 100 an opportunity to save himself at the first sign of a problem. Similar to the first remote activator 24, the second remote activator 28 is coupled to the solenoid 22 and can be operated by a trigger switch on the remote activator 28. It is contemplated that a remote activator 28 is attached to the individual, such as their work belt, every time they enter a manhole 100 to perform inspection. As previously mentioned, electrical arcing may occur at any time and the larger volume of air allowed by the removal of the manhole cover 102 may result in an unexpected fire burst. Similarly, where a fireman is called in to determine the reason for some arising from a manhole 100, the removal of the manhole 100 cover may allow a volume of air to enter the area to support full blown combustion. It should be noted that even if an electrical grid is turned off for inspection, a smoldering fire may irrupt irrespective of the presence of electricity. In manholes that lead to tunnels, the worker may leave the second remote activator 28 at the bottom of the ladder 104. Should a fire occur, the worker that returns to the ladder 104 can active the system providing a shower of fire suppressant material that will give him the time necessary to escape the manhole.

A variation of the cabled remote is the use of a wireless transmitter 32 which works on a radio frequency. The transmitter would signal a receiver 34 mounted to the solenoid 22 or a repeater mounted at the entrance of the ladder that would signal the solenoid mounted receiver 34. At a minimum, a 2.4 GHz transmitter should be suitable to placed within the manhole 100 and transmit to a receiver, without a repeater, if the receiver is positioned with 30 feet of the manhole 100. Battery condition of the solenoid, whether operated by a cabled trigger switch or a wireless transmitter 32 can be verified by use of an indicator light that indicates the condition of the battery is sufficient for operation. Another light indicator can be employed to verify the container is filled with fluid and pressurized. Lithium battery technology would allow a replacement period expected to exceed ten years as the system is to be used only for emergencies, and the battery draw during that time would be limited to low draw LED operational indicator lights.

In a preferred embodiment, the wireless transmitter 32 is mounted to a wrist band 36 that can be positioned around an individual's wrist before they enter the manhole 100. Radio frequency has a drawback when placed beneath the ground level requiring the wireless transmitter 32 to be placed within a range of the manhole 100 to assure proper operation. A proximity sensor can be used to assure the transmitter and receiver is within operating range, with a flashing light on the both the solenoid and the receiver to indicate if the devices are out of range. It should be noted that while a wrist band is described, any type of attachment convenient to the individual is contemplated include a pendant worn around the neck and belt attachment similar to a garage door opener bracket.

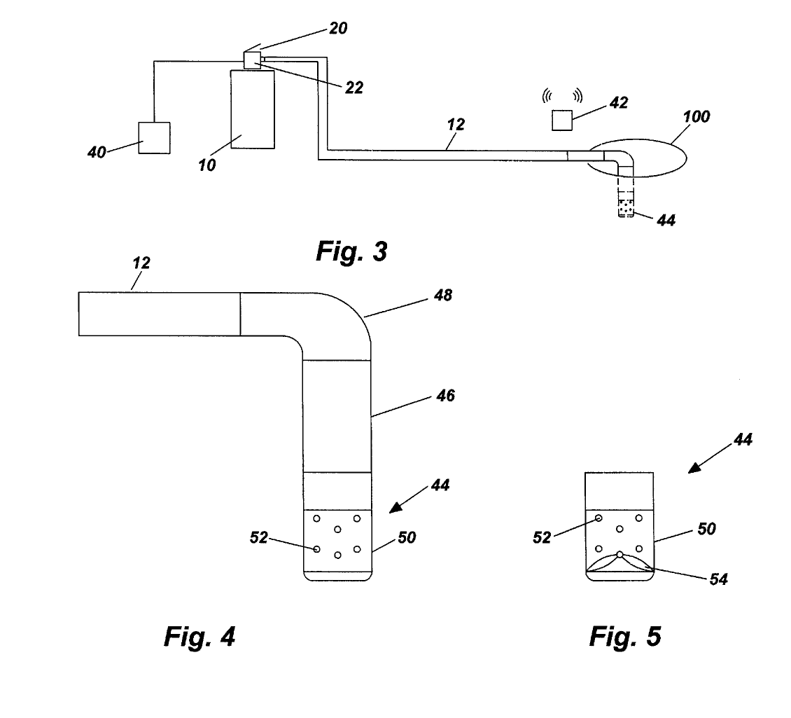

Referring to FIG. 3, the container 10 can be charged by a compressed gas container 40. The container 10 can again be discharged like a conventional fire extinguisher wherein handle 20 can be manually operated by a co-worker monitoring the individual within the manhole 100. The solenoid 22 is positioned on the container 10 allowing for a remote discharge by use of a wireless transmitter 42 that can be carried by the worker, or attached to the worker wherein the wireless transmitter operates automatically such as by fire or heat.

The container 10 holds the fire suppressant which is directed into the manhole 100 by use of a distribution nozzle 44 that is fluidly coupled to the container 10 by a fluid hose 12. The hose can be 10-50 foot long allowing the placement of the container a distance from the manhole 100. The distribution nozzle 44 is constructed and arranged to be placed over the edge of the manhole 100 opening so that an individual can enter and exit uninhibited. The distribution nozzle 44 includes a rigid holder which consists of a hanger pipe that is of a length to place the distribution nozzle 44 beneath the street surface and an elbow 48 that allows for a 90 degree angle change without crimping the admixture flow. The distribution nozzle 44 has a rotating sleeve having a plurality of openings 52. The sleeve is rotated upon receipt of a fluid flow by use of an impeller 54 that causes rotation upon the pressurized fluid flow into the distribution nozzle 44. The impeller 54 is but one example of how to cause rotation of the distribution nozzle, the objective of the nozzle is to provide a distribution of the admixture during the situation. The nozzle need only handle a low volume flow of about 10 gallons total allowing for use of a ½″ or less sized distributor. A fixed nozzle may also be used wherein the openings are constructed and arranged to provide an overlapping pattern of admixture distribution. The nozzles are constructed to distribute an amount of the admixture in sufficient quantity to cover the individual, the ladder, and the immediate area beneath the manhole. If the individual's clothing is on fire, the admixture will extinguish the fire and suppress the spread of the fire. The admixture will also protect the individual's skin from exposure to the fire. Further, the admixture will inhibit the fire from damaging the integrity of the ladder so as to provide the individual with sufficient time to exit the manhole.

The viscosity of the admixture of fire suppressant allows attachment to whatever is spayed and the admixture will not move or migrate past the area into which it was introduced. Therefore, the admixture can be delivered to a specific area within a tunnel and it will remain in that area and will not flow into areas that are not sprayed. Spraying the individuals clothing and exposed skin is most preferred, the admixture provides fire extinguishing qualities also provides fire and heat retardant properties. Further, once the individual is within the spray area, noxious and/or toxic gasses are entrapped again providing the individual with additional time to exit the manhole.

In some embodiments, the fire suppressant composition comprises one or more fire suppressant compounds. In other embodiments, the fire suppressant composition comprises one or more common components of fire suppressant formulations, such as: fire suppressant salts, known or conventional fire suppressants, corrosion inhibitors, spoilage inhibitors, foaming agents, non foaming agents, flow conditioners, stability additives, thickening agents, pigments, dyes or the like.

In some embodiments, a conventional fire suppressant comprises penta-bromodiphenyl ether, octa-bromodiphenyl ether, deca-bromodiphenyl ether, short-chain chlorinated paraffins (SCCPs), medium-chain chlorinated paraffins (MCCPs), hexabromocyclododecane (HBCD), tetrabromobisphenol A (TBBPA), tetrabromobisphenol A ether, pentabromotoluene, 2,3-dibromopropyl-2,4,6-tribromophenyl ether, tetrabromobisphenol A, bis(2,3-dibromopropyl ether), tris(tribromophenoxy)triazine, tris(2-chloroethyl)phosphate (TCEP), tris(2-chloro-1-methylethyl)phosphate (TCPP or TMCP), tris(1,2-dichloropropyl)phosphate (TDCP), 2,2-bis(chloromethyl)-trimethylene bis(bis(2-chloroethyl)phosphate), melamine cyanurate, antimony trioxide Sb₂O₃ (ATO), boric acid, ammonium polyphosphate (APP), aluminum ammonium polyphosphate, aluminum hydroxide, magnesium hydroxide red phosphorous, 1,2-bis(tribromophenoxy)ethane, 2,4,6-tribromophenyl glycidyl ether, tetrabromo phthalic anhydride, 1,2-bis(tetrabromo phthalimide)ethane, tetrabromo dimethyl phthalate, tetrabromo disodium phthalate, decabromodiphenyl ether, tetradecabromodi(phenoxyl)benzene, 1,2-bis(pentabromophenyl)ethane, bromo-trimethyl-phenyl-hydroindene, pentabromobenzyl acrylate, pentabromobenzyl bromide, hexabromobenzene, pentabromotoluene, 2,4,6-tribromophenyl maleimide, hexabromo cyclododecane, N,N′-1,2-bis(dibromonorbornyl dicarbimide)ethane, pentabromochloro-cyclohexane, tri(2,3-dibromopropyl)isocyanurate, bromo-styrene copolymer, tetrabromobisphenol A-carbonate oligomer, polypentabromobenzyl acrylate, polydibromophenylene ether; chlorinated flame retardants such as: dechlorane plus, HET anhydride (chlorendic anhydride), perchloro pentacyclodecane, tetrachloro bisphenol A, tetrachlorophthalic anhydride, hexachlorobenzene, chlorinated polypropylene, chlorinated polyvinyl chloride, vinyl chloride-vinylidene chloride copolymer, chlorinated polyether, hexachloroethane; organic phosphorus flame retardants such as: 1-oxo-4-hydroxymethyl-2,6,7-trioxa-1-phosphabicyclo[2,2,2]octane, 2,2-dimethyl-1,3-propanediol-di(neopentyl glycol)diphosphate, 9,10-di hydro-9-oxa-10-phosphaphenanthrene-10 oxide, bis(4-carboxyphenyl)-phenyl phosphine oxide, bis(4-hydroxyphenyl)-phenyl phosphine oxide, phenyl(diphenyl sulfone)phosphate oligomer; phosphorus-halogenated flame retardants such as tris(2,2-di(bromomethyl)-3-bromopropyl)phosphate, tris(dibromophenyl)phosphate, 3,9-bis(tribromophenoxy)-2,4,8,10-tetraoxa-3,9-diphosphaspiro[5,5]-3,9-di-oxo-undecane, 3,9-bis(pentabromophenoxy)-2,4,8,10-tetraoxa-3,9-diphosphaspiro[5,5]-3,9-dioxo-undecane, 1-oxo-4-tribromophenoxycarbonyl-2,6,7-trioxa-1-phosphabicyclo[2,2,2]octane, p-phenylene-tetrakis(2,4,6-tribromophenyl)-diphosphate, 2,2-di(chloromethyl)-1,3-propanediol-di(neopentyl glycol)diphosphate, 2,9-di(tribromo-neopentyloxy)-2,4,8,10-tetraoxa-3,9-diphosphaspiro[5,5]-3,9-dioxo-undecane; nitrogen-based flame retardants or phosphorus-nitrogen-based flame retardants such as melamine, melamine cyanurate, melamine orthophosphate, dimelamine orthophosphate, melamine polyphosphate, melamine borate, melamine octamolybdate, cyanuric acid, tris(hydroxyethyl)isocyanurate, 2,4-diamino-6-(3,3,3-trichloro-propyl)-1,3,5-triazine, 2,4-di(N-hydroxymethyl-amino)-6-(3,3,3-trichloro-propyl-1,3,5-triazine), diguanidine hydrophosphate, guanidine dihydrogen phosphate, guanidine carbonate, guanidine sulfamate, urea, urea dihydrogen phosphate, dicyandiamide, melamine bis(2,6,7-trioxa-phosphabicyclo[2.2.2]octane-1-oxo-4-methyl)-hydroxy-phosphate, 3,9-dihydroxy-3,9-dioxo-2,4,8,10-tetraoxa-3,9-diphosphaspiro[5.5]u-ndecane-3,9-dimelamine, 1,2-di(2-oxo-5,5-dimethyl-1,3-dioxa-2-phosphacyclohexyl-2-amino)ethane, N,N′-bis(2-oxo-5,5-dimethyl-1,3-dioxa-2-phosphacyclohexyl)-2,2′-m-phenyle-nediamine, tri(2-oxo-5,5-dimethyl-1,3-dioxa-2-phosphacyclohexyl-2-methyl)a-mine, hexachlorocyclotriphosphazene; and inorganic flame retardants such as: red phosphorus, ammonium polyphosphate, diammonium hydrophosphate, ammonium dihydrogen phosphate, zinc phosphate, aluminum phosphate, boron phosphate, antimony trioxide, aluminum hydroxide, magnesium hydroxide, hydromagnesite, alkaline aluminum oxalate, zinc borate, barium metaborate, zinc oxide, zinc sulfide, zinc sulfate heptahydrate, aluminum borate whisker, ammonium octamolybdate, ammonium heptamolybdate, zinc stannate, stannous oxide, stannic oxide, ferrocenc, ferric acetone, ferric oxide, ferro-ferric oxide, ammonium bromide, sodium tungstate, potassium hexafluorotitanate, potassium hexafluorozirconate, titanium dioxide, calcium carbonate, barium sulfate, sodium bicarbonate, potassium bicarbonate, cobalt carbonate, zinc carbonate, basic zinc carbonate, heavy magnesium carbonate, basic magnesium carbonate, manganese carbonate, ferrous carbonate, strontium carbonate, sodium potassium carbonate hexahydrate, magnesium carbonate, calcium carbonate, dolomite, basic copper carbonate, zirconium carbonate, beryllium carbonate, sodium sesquicarbonate, cerium carbonate, lanthanum carbonate, guanidine carbonate, lithium carbonate, scandium carbonate, vanadium carbonate, chromium carbonate, nickel carbonate, yttrium carbonate, silver carbonate, praseodymium carbonate, neodymium carbonate, samarium carbonate, europium carbonate, gadolinium carbonate, terbium carbonate, dysprosium carbonate, holmium carbonate, erbium carbonate, thulium carbonate, ytterbium carbonate, lutetium carbonate, aluminum diacetate, calcium acetate, sodium bitartrate, sodium acetate, potassium acetate, zinc acetate, strontium acetate, nickel acetate, copper acetate, sodium oxalate, potassium oxalate, ammonium oxalate, nickel oxalate, manganese oxalate dihydrate, iron nitride, sodium nitrate, magnesium nitrate, potassium nitrate, zirconium nitrate, calcium dihydrogen phosphate, sodium dihydrogen phosphate, sodium dihydrogen phosphate dihydrate, potassium dihydrogen phosphate, aluminum dihydrogen phosphate, ammonium dihydrogen phosphate, zinc dihydrogen phosphate, manganese dihydrogen phosphate, magnesium dihydrogen phosphate, disodium hydrogen phosphate, diammonium hydrogen phosphate, calcium hydrogen phosphate, magnesium hydrogen phosphate, ammonium phosphate, magnesium ammonium phosphate, ammonium polyphosphate, potassium metaphosphate, potassium tripolyphosphate, sodium trimetaphosphate, ammonium hypophosphite, ammonium dihydrogen phosphite, manganese phosphate, dizinc hydrogen phosphate, dimanganese hydrogen phosphate, guanidine phosphate, melamine phosphate, urea phosphate, strontium dimetaborate hydrogen phosphate, boric acid, ammonium pentaborate, potassium tetraborate octahydrate, magnesium metaborate octahydrate, ammonium tetraborate tetrahydrate, strontium metaborate, strontium tetraborate, strontium tetraborate tetrahydrate, sodium tetraborate decahydrate, manganese borate, zinc borate, ammonium fluoroborate, ammonium ferrous sulfate, aluminum sulfate, potassium aluminum sulfate, ammonium aluminum sulfate, ammonium sulfate, magnesium hydrogen sulfate, aluminum hydroxide, magnesium hydroxide, iron hydroxide, cobalt hydroxide, bismuth hydroxide, strontium hydroxide, cerium hydroxide, lanthanum hydroxide, molybdenum hydroxide, ammonium molybdate, zinc stannate, magnesium trisilicate, telluric acid, manganese tungstate, manganite, cobaltocene, 5-aminotetrazole, guanidine nitrate, azobisformamide, nylon powder, oxamide, biuret, pentaerythritol, decabromodiphenyl ether, tetrabromo-phthalic anhydride, dibromoneopentyl glycol, potassium citrate, sodium citrate, manganese citrate, magnesium citrate, copper citrate, ammonium citrate, nitroguanidine.

In some embodiments, the fire suppressant or compositions thereof are in dry form. In other embodiments, the fire suppressant or compositions thereof are hydrated. The fire suppressant or compositions thereof can be a liquid, foam, or semi-liquid form, such as, for example, a gel having varying viscosities.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for suppressing a manhole electrical fire comprising:
a container;
an admixture of non-conductive fire suppressant stored within said container;
a distribution structure fluidly coupled to said container, said distribution structure having at least one spray nozzle juxtapositioned to a manhole opening; and
an activation means positioned between said container and said distribution structure, said activation means for use in releasing said stored admixture into said nozzle for dispensing through said manhole opening.

2. The device for suppressing a manhole electrical fire according to claim 1 wherein said distribution structure is a ring shaped member constructed and arranged for placement along an edge of an open manhole.

3. The device for suppressing a manhole electrical fire according to claim 2 wherein said distribution structure includes a plurality of spray nozzles having a directional spray pattern into the manhole opening.

4. The device for suppressing a manhole electrical fire according to claim 3 wherein said spray nozzles provide overlapping spray patterns of said admixture.

5. The device for suppressing a manhole electrical fire according to claim 1 wherein said nozzle rotates for distribution of said admixture of non-conductive fire suppressant.

6. The device for suppressing a manhole electrical fire according to claim 1 wherein said container is coupled to said distribution structure by a flexible hose.

7. The device for suppressing a manhole electrical fire according to claim 1 wherein said activation means is a manually operated valve.

8. The device for suppressing a manhole electrical fire according to claim 1 wherein said activation means is a battery operated solenoid.

9. The device for suppressing a manhole electrical fire according to claim 8 including at least one remote trigger electrically coupled to said solenoid.

10. The device for suppressing a manhole electrical fire according to claim 9 wherein said remote trigger is wireless.

11. The device for suppressing a manhole electrical fire according to claim 1 wherein said admixture is effective in reducing airborne organic compounds and airborne metals when added to an active arc fault.

12. The device for suppressing a manhole electrical fire according to claim 1 wherein said storage container is pressurized with a compressed gas.

13. A device for suppressing a manhole electrical fire comprising:
a container pressurized with a compressed gas;
an admixture of non-conductive fire suppressant stored within said container;
a distribution ring fluidly coupled to said container sized for placement about a manhold opening, said distribution ring having at least one spray nozzle directed into the manhole opening; and
a battery operated solenoid valve positioned between said container and said distribution ring, said solenoid for use in releasing said stored admixture into said nozzle for dispensing through said manhole opening upon activation.

14. The device for suppressing a manhole electrical fire according to claim 13 wherein said distribution ring includes a plurality of spray nozzles having a directional spray pattern into the manhole opening.

15. The device for suppressing a manhole electrical fire according to claim 13 wherein said container is coupled to said distribution structure by a flexible hose.

16. The device for suppressing a manhole electrical fire according to claim 13 including at least one remote trigger electrically coupled to said solenoid.

17. The device for suppressing a manhole electrical fire according to claim 16 wherein said remote trigger is wireless.
